(19) United States
(12) Patent Application Publication
(10) Pub. No.: US 2021/0262809 A1
(43) Pub. Date: Aug. 26, 2021

(54) ESTIMATION AND PRESENTATION OF TOTAL JOURNEY TIME FROM ORIGIN TO GATE

(71) Applicant: Alclear, LLC, New York, NY (US)

(72) Inventors: Caryn Seidman-Becker, New York, NY (US); Rob Wisniewski, New York, NY (US); Greg Levitt, New York, NY (US); Navni Garg, New York, NY (US); Nick Greene, New York, NY (US); Josh Rooke-Ley, New York, NY (US)

(21) Appl. No.: 17/185,405

(22) Filed: Feb. 25, 2021

Related U.S. Application Data
(60) Provisional application No. 62/981,249, filed on Feb. 25, 2020.

(51) Int. Cl. G01C 21/34

(52) U.S. Cl. CPC G01C 21/343; G01C 21/3423; G01C 21/3415

(57) ABSTRACT

A system estimates travel time to an airport gate. The system ascertains a start and an airport gate for a journey. The system obtains time data related to segments of the journey. For example, the system may obtain driving or other navigation direction time estimates, walk times to gates in airports, current traffic conditions, security processing times at airports, and so on. The system generates a journey time output using the time data. The system may also provide the journey time output, such as in the form of a unified timeline from a person's home or other start or origin to the airport gate.

### CROSS-REFERENCE TO RELATED APPLICATION(S)

This application is a nonprovisional patent application of and claims the benefit of U.S. Provisional Patent Application No. 62/981,249, filed Feb. 25, 2020 and titled “Estimation and Presentation of Total Journey Time from Origin to Gate,” the disclosure of which is hereby incorporated herein by reference in its entirety.

### FIELD

The described embodiments relate generally to journey time estimation. More particularly, the present embodiments relate to estimation and presentation of total journey time from origin to gate.

### BACKGROUND

People experience increasing demands on their time. In order to meet these demands, people attempt to accomplish increasingly higher amounts of tasks within the same amount of time. Given that time periods are finite, there is a limit to the amount of tasks that can be accomplished within those time periods. In order to accomplish more, people may look to eliminate or reduce portions of their day where time is wasted.

One area where time may be wasted is travel for flights or similar activities. The consequences of being late may be severe, such as expense or time required for rebooking if a flight is missed. As a result, people may compensate by being overly early for a flight to ensure that there is no possibility that they miss their flight. This may avoid missing flights, but may waste a great deal of time due to being so overly early.

### SUMMARY

The present disclosure relates to estimation and presentation of total journey time from origin to gate. A start and an airport gate for a journey may be ascertained. Time data related to segments of the journey may be obtained. For example, driving or other navigation direction time estimates may be obtained, walk times to gates in airports may be obtained, current traffic conditions may be obtained, security processing times at airports may be obtained, and so on. A journey time output may be generated using the time data. The journey time output may be provided, such as in the form of a unified timeline from a person's home or other start or origin to the airport gate.

In various embodiments, a system for estimating travel time to an airport gate includes a non-transitory storage medium that stores instructions and a processor. The processor executes the instructions to ascertain a start and the airport gate for a journey, obtain time data related to segments of the journey, generate a journey time output, and provide the journey time output.

In some examples, the journey time output includes at least a first estimated time to travel from the start to an airport associated with the airport gate, a second estimated time to pass through security screening, and a third estimated time to travel from the security screening to the airport gate. In a number of implementations of such examples, the journey time output further includes a total estimated time generated at least by adding the first estimated time, the second estimated time, and the third estimated time. In some implementations of such examples, the journey time output further includes a fourth estimated time to check baggage. In various implementations of such examples, the journey time output further includes a fourth estimated time for service at a ticket counter.

In a number of examples, obtaining the time data includes obtaining traffic data from a traffic data source, the traffic data related to one of the segments of the journey from the start to an airport associated with the airport gate. In various examples, obtaining the time data includes obtaining a walk time from a database of airport walk times to gates.

In some embodiments, a system for estimating travel time to an airport gate includes a non-transitory storage medium that stores instructions and a processor. The processor executes the instructions to obtain time data related to segments of journeys to airport gates, maintain a database of the time data, receive a request for a journey time output associated with a journey, generate the journey time output using at least the database, and provide the journey time output.

In various examples, the request specifies the airport gate for the journey. In a number of examples, the request specifies a start for the journey.

In some examples, the processor modifies the journey time output in response to a change request. In various implementations of such examples, the change request changes a route to an airport associated with the journey. In some implementations of such examples, the change request changes a method of travel to an airport associated with the journey.

In a number of embodiments, a system for estimating travel time to an airport gate includes a non-transitory storage medium that stores instructions and a processor. The processor executes the instructions to receive a request for a journey time output from a requestor, determine an identity of the requestor, ascertain a start and the airport gate for a journey, obtain time data related to the journey, determine at least one alteration to make to the journey based on previous behavior associated with the identity, and generate the journey time output.

In various examples, the processor determines the airport gate based at least on ticket data associated with the identity. In some examples, the processor determines the start based at least on address information associated with the identity. In a number of examples, the processor determines the start based at least on a current location of an electronic device associated with the identity. In some examples, the processor determines the start based at least on a current location of an electronic device used to submit the request. In various examples, the processor transmits the journey time output to an electronic device used to submit the request. In a number of examples, the processor provides a suggestion regarding an alternative behavior resulting in a shorter estimated journey time.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example system for estimating travel time to an airport gate.

FIG. 2 depicts a flow chart illustrating a first example method for estimating travel time to an airport gate. This method may be performed by the system of FIG. 1.

FIG. 3 depicts a flow chart illustrating a second example method for estimating travel time to an airport gate. This method may be performed by the system of FIG. 1.

FIG. 4 depicts a flow chart illustrating a third example method for estimating travel time to an airport gate. This method may be performed by the system of FIG. 1.

FIG. 5 depicts a flow chart illustrating a fourth example method for estimating travel time to an airport gate. This method may be performed by the system of FIG. 1.

FIG. 6 depicts a flow chart illustrating a fifth example method for estimating travel time to an airport gate. This method may be performed by the system of FIG. 1.

FIG. 7 depicts a block diagram illustrating example relationships between example components that may be used to implement the user interaction computing device and the server computing device of the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

There are many factors that may contribute to uncertainty regarding the amount of journey time from an origin or other start to an airport gate or similar destination. One issue is that there is not a way to estimate and/or present the journey time for the entire journey from home or other origin or start to the airport gate. People may cobble different systems together in an attempt to achieve this comprehensive view, such as by combining the typical amount of time it takes them to drive to the airport with the generic advice typically provided to arrive at airports 2 hours before domestic flights and 3 hours before international flights. However, this approach is extremely vague and does not take into account any kind of current conditions that may change travel time to airports, time to travel within airports, and so on.

Some people may attempt to increase the accuracy of these estimates by using driving directions that provide current time estimates. However, this would only increase the accuracy of a portion of the journey. The airport portion of the journey would still depend on arriving so early before a flight that missing the flight is not possible.

This approach could be made even more accurate by measuring walk times to gates within airports. However, this would still not take current airport conditions into account. For example, the time to walk to a gate could vary more than an hour between a flight time at 3 in the morning on a routine Tuesday versus the Christmas holiday given the way that security processing times depend on total passenger traffic.

The following disclosure relates to estimation and presentation of total journey time from origin to gate. A start and an airport gate for a journey may be ascertained. Time data related to segments of the journey may be obtained. For example, driving or other navigation direction time estimates may be obtained, walk times to gates in airports may be obtained, current traffic conditions may be obtained, security processing times at airports may be obtained, and so on. A journey time output may be generated using the time data. The journey time output may be provided, such as in the form of a unified timeline from a person's home or other start or origin to the airport gate.

In this way, functionality may be provided that was not previously possible in the form of a uniform timeline journey time estimate from origin to airport gate. Additionally, functionality may be provided that was not previously possible in the form of the time estimates being more accurate than previously possible and taking into account real time conditions at various stages of the journey. Further, the operation of systems and/or electronic devices involved in such estimates may be improved by reducing the various queries and determinations that would be performed by people attempting to cobble together journey time estimates from existing systems. Fewer hardware and/or software resources would be required, excessive network communication would be minimized, duplicate hardware and/or software resources may be eliminated, and so on.

Various configurations are possible and contemplated without departing from the scope of the present disclosure. These and other embodiments are elaborated in more detail below.

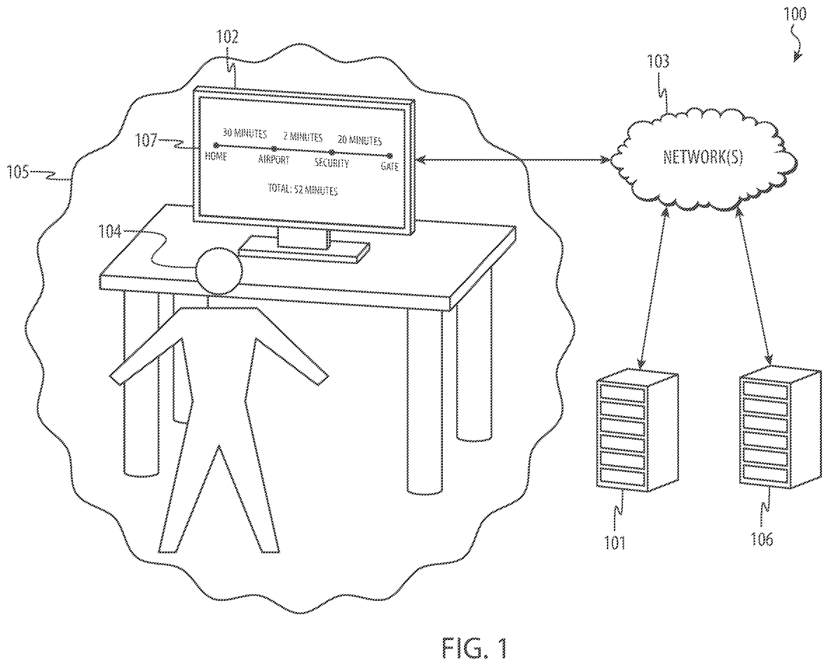

These and other embodiments are discussed below with reference to FIGS. 1-7. However, those skilled in the art will readily appreciate that the detailed description given herein with respect to these Figures is for explanatory purposes only and should not be construed as limiting.

FIG. 1 depicts a first example system 100 for estimating travel time to an airport gate. The system 100 may include one or more server computing devices 101 that are operable to communicate with one or more user interaction computing devices 102 and/or other computing devices 106 via one or more wired and/or wireless communication networks 103. The server computing device 101 may ascertain a start and an airport gate for a journey, obtain time data related to segments (or portions that the journey may be divided into) of the journey (such as driving or other navigation direction time estimates, walk times to gates in airports, current traffic conditions, security processing times at airports, and so on obtained from one or more traffic and/or other data sources via the other computing devices 106), and generate a journey time output using the time data. The server computing device 101 may also provide the journey time output, such as in the form of a unified timeline from a home 105 of a user 104 or other start or origin to the airport gate.

By way of illustration, a user 104 may use the user interaction computing device 102 at a home 105 of the user 104 to request a journey time output. The server computing device 101 may ascertain a start for the journey, such as based on start data specified in the request, start data retrieved from stored identity information that corresponds to a determined identity of the user 104 (which may be determined using one or more provided digital representations of biometrics, logins, passwords, account identifiers, and so on), start data determined based on a location of the user interaction computing device 102, and so on. The server computing device 101 may also ascertain an airport gate for the journey, such as based on airport gate data specified in the request, airport gate data retrieved from stored identity information that corresponds to a determined identity of the user 104 (which may be determined using one or more provided digital representations of biometrics (such as a digital representation of a fingerprint, a voiceprint, a facial image, a retina image, an iris image, a deoxyribonucleic acid sequence, a heart rhythm, a gait, a palm scan, a hand scan, a vein scan, a blood scan, a vein image, and so on obtained via one or more biometric reader devices, such as a fingerprint scanner, a palm scanner, a hand scanner, a vein scanner, a blood scanner, an optical fingerprint scanner, a phosphorescent fingerprint scanner, a camera, an image sensor, a saliva sensor, a deoxyribonucleic acid sensor, a heart rhythm monitor, a microphone, and so on), logins, passwords, account identifiers, and so on), airport gate data determined by accessing a secure flight database or other database using information retrieved from the stored identity information, and so on. The server computing device 101 may further obtain time data related to segments of the journey. For example, the server computing device 101 may be a component of a biometric identification system operable to biometrically identify people at one or more airports (such as for verifying identity for security screening, verifying valid identification and/or boarding passes, processing payments, and so on) and may track and/or estimate travel times through various portions of the airports (such as time for security processing, time for checking baggage, time to wait for service at ticket counters, and so on) using data gathered as part of performing such biometric identifications. The server computing device 101 may additionally generate and provide the journey time output, which may be presented on a display 107 or other output device of the user interaction computing device 102.

For example, as illustrated, the display 107 may present a journey time estimate that depicts the entire journey from the home 105 of the user 104 to the airport gate including one or more of multiple segments, estimated times for each segment, a total time estimate (which may be generated at least by adding the estimated times for each segment), and so on. Although the journey time estimate is illustrated in a particular graphical format, it is understood that this is an example and that various other configurations are possible and contemplated without departing from the scope of the present disclosure.

In this way, functionality may be provided that was not previously possible in the form of a uniform timeline journey time estimate from origin to airport gate. Additionally, functionality may be provided that was not previously possible in the form of the time estimates being more accurate than previously possible and taking into account real time conditions at various stages of the journey. Further, the operation of systems and/or electronic devices involved in such estimates may be improved by reducing the various queries and determinations that would be performed by people attempting to cobble together journey time estimates from existing systems. Fewer hardware and/or software resources would be required, excessive network communication would be minimized, duplicate hardware and/or software resources may be eliminated, and so on.

FIG. 1 illustrates and describes the journey time output as a single sequence of segments. However, it is understood that this is an example and that various other configurations are possible and contemplated without departing from the scope of the present disclosure. For example, in various implementations, multiple options may be available for travel between a start and an airport. Such multiple options may include multiple different possible routes, multiple different possible transportation options (such as driving, walking, rideshare, taxi, train, bus, combinations thereof, and so on), and so on. In such implementations, the journey time estimate may be generated using one of the multiple options (such as a default, a time optimized selection, a cost optimized selection, a selection based on previous user behavior, a selection based on a user specified default, and so on). In various examples of such implementations, the user 104 may be able to select a different option of the multiple options by submitting a change request to cause the journey time estimate to be re-generated and re-provided using the different option instead of the option previously selected. In some examples, time and/or other factors for the multiple options may be presented in order for the user 104 to make informed choices, such as an indication that the user 104 driving may be the fastest way to get to the airport, but that this option would also include time for the user 104 to park a vehicle and travel from the parking area to a main area of the airport.

By way of another example, multiple options may be available for travel within various portions of the airport. In such implementations, the journey time estimate may be generated using one of the multiple options and the user 104 may be able to cause the journey time estimate to be re-generated and re-provided using a different option instead. By way of illustration, the journey time estimate may include a time estimate for security screening, but an expedited security screening (such as to members of an expedited security screening service) may be available. The journey time estimate may indicate the time estimate differences between the security screening and the expedited security screening, as well as information regarding how the user 104 can sign up for the expedited security screening in order to take advantage of a time benefit.

In still another example, the server computing device 101 may determine to make at least one alteration to the journey based on previous behavior associated with the user 104. By way of illustration, the user 104 may previously have visited a ticket counter before flights even when not checking a bag. This behavior may be monitored and tracked. As such, the server computing device 101 may generate the journey time estimate as including an unnecessary visit to a ticket counter as well as an indication that the user 104 may save time by skipping the ticket counter (which may be made possible by one or more suggested actions, such as using a biometric identification system for passing through security that does not require the user 104 to obtain a boarding pass) and a prompt to re-generate and re-present the journey time estimate with skipping the ticket counter. Other alterations may include typical routes taken, typical routes through airports taken, typical visits to airline and/or other lounges while in the airport, and so on. Various configurations are possible and contemplated without departing from the scope of the present disclosure.

In some examples, the server computing device 101 and/or another device may use behavioral traits of the user 104 when generating the journey time output. For example, the server computing device 101 and/or another device may store and/or have access to data regarding behavioral traits of the user 104, such as transportation options (such as the user 104 driving his own vehicle, taking a bus, taking a train, taking a taxi, using a rideshare service, using an autonomous vehicle, and so on) that the user 104 typically uses, routes that the user 104 typically travels, whether or not the user 104 typically stops for lunch and/or other meals before a flight or other destination, whether or not the user 104 typically stops for coffee and/or other items before a flight or other destination, airport and/or other services the user 104 typically uses, whether or not the user 104 typically obtains assistance for traveling through an airport and/or other area, and so on. The server computer 101 and/or another device may make assumptions about the journey the user 104 will take when generating the journey time output. These assumptions may be based on behavior traits the user 104 typically engages in and/or may have associated times. For example, the server computer 101 and/or another device may use a first transit time associated with the user 104 driving his own vehicle when the data regarding behavior traits indicates that the user 104 typically drives his own vehicle and a second transit time associated with the user 104 taking a rideshare service when the data regarding behavior traits indicates that the user 104 typically takes a rideshare service. Various configurations are possible and contemplated without departing from the scope of the present disclosure.

Alternatively and/or additionally, the server computing device 101 and/or another device may prompt the user 104 to answer one or more questions in order to further hone the journey time output. For example, instead of modifying the journey time output based on assumptions made about the user 104 using behavior traits of the user 104, the server computing device and/or another device may prompt the user 104 to indicate which transportation option (such as the user 104 driving his own vehicle, taking a bus, taking a train, taking a taxi, using a rideshare service, using an autonomous vehicle, and so on) the user 104 will use, a route that the user 104 will travel, whether or not the user 104 will stop for lunch and/or another meal before a flight or other destination, whether or not the user 104 will stop for coffee and/or other items before a flight or other destination, airport and/or other services the user 104 will use, whether or not the user 104 will obtains assistance for traveling through an airport and/or other area, and so on. The server computer 101 and/or another device may generate the journey time output and/or modify the journey time output using one or more of the responses from the user 104 to one or more such questions. These responses may have associated times. For example, the server computer 101 and/or another device may use a first transit time associated with the user 104 driving his own vehicle when the user 104 responds that he will drive his own vehicle and a second transit time associated with the user 104 taking a rideshare service when the user 104 indicates that he will take a rideshare service. Various configurations are possible and contemplated without departing from the scope of the present disclosure.

In still other examples, the server computing device 101 and/or another device may use stored data regarding behavior traits of the user 104 as well as prompt the user to answer one or more questions and generate and/or modify the journey time output accordingly. By way of illustration, the server computing device 101 and/or another device may use stored data regarding behavior traits of the user 104 in order to determine one or more questions to ask, such as determining to ask the user 104 which transportation option the user 104 will use when stored data regarding behavior traits indicates that the user 104 often uses different transportation options. Various configurations are possible and contemplated without departing from the scope of the present disclosure.

Alternatively and/or additionally, the stored data regarding behavior traits may indicate that the user 104 typically uses a rideshare service but may not indicate whether or not the user 104 typically stops for lunch and/or another meal before a flight and/or another destination. As such, the server computing device 101 and/or another device may assume that the user 104 will use the rideshare service, ask the user 104 whether or not the user will stop for lunch and/or another meal before a flight and/or another destination, and use the assumption and the response from the user 104 to the question to generate and/or modify the journey time output. for lunch and/or another meal before a flight and/or another destination. Various configurations are possible and contemplated without departing from the scope of the present disclosure.

In various examples, one or more components of the system 100 may interact with one or more other applications and/or devices in addition to generating and providing the journey time output. By way of illustration, the server computing device 100 and/or another device may use information obtained as part of and/or in addition to generating the journey time output to summon and/or otherwise book transportation for the user 104. For example, the server computing device 100 and/or another device may use information obtained as part of and/or in addition to generating the journey time output to summon an autonomous vehicle and/or rideshare service and/or other transportation option for the user 104 to take the user 104 from the start to the airport associated with the airport gate. Various configurations are possible and contemplated without departing from the scope of the present disclosure.

Additionally and/or alternatively, the server computing device 100 and/or another device may summon an autonomous vehicle and/or rideshare service and/or other transportation option for the user 104 to take the user 104 from the start to the airport associated with the airport gate and then control and/or otherwise direct the route that the autonomous vehicle and/or rideshare service and/or other transportation option uses to take the user 104 from the start to the airport. For example, the server computing device 100 and/or another device may control and/or otherwise direct the route according to route assumptions used to generate the journey time output. By way of another example, the server computing device 100 and/or another device may control and/or otherwise change the route currently being taken by the autonomous vehicle and/or rideshare service and/or other transportation option in order to maintain the previously provided journey time output. Various configurations are possible and contemplated without departing from the scope of the present disclosure.

In still other examples, the server computing device 100 and/or another device may obtain information from an autonomous vehicle and/or rideshare service and/or other transportation option that is taking the user 104 from the start to the airport associated with the airport gate. The server computing device 100 and/or another device may use such information to generate the journey time output, modify a previously provided journey time output, and so on. For example, the server computing device 100 and/or another device may obtain information from an autonomous vehicle and/or rideshare service and/or other transportation option that is taking the user 104 from the start to the airport associated with the airport gate indicating that the autonomous vehicle and/or rideshare service and/or other transportation option will take a different amount of time than previously estimated to take the user 104 from the start to the airport associated with the airport gate. In response, the server computing device 100 and/or another device may update the journey time output and/or provide the updated journey time output to the user 104. In this way, the user 104 may be provided updates regarding changes to the provided journey time output in real time. This may enable the user 104 to change plans in response to changed journey time output, such as skipping a planned lunch when travel time exceeds a previous estimate, rebooking a flight that will be missed, switching routes to ensure arrival in time for a flight, and so on. Various configurations are possible and contemplated without departing from the scope of the present disclosure.

Although the above is illustrated and described as generating and providing the journey time output in response to a request from the user 104, it is understood that this is an example. In other implementations, the journey time estimate may be generated and/or provided without involvement by the user 104. For example, the journey time estimate may be automatically generated and/or provided as a time for a flight approaches, as the system 100 determines that the user 104 needs to begin travel in order to make a flight, and so on. Various configurations are possible and contemplated without departing from the scope of the present disclosure.

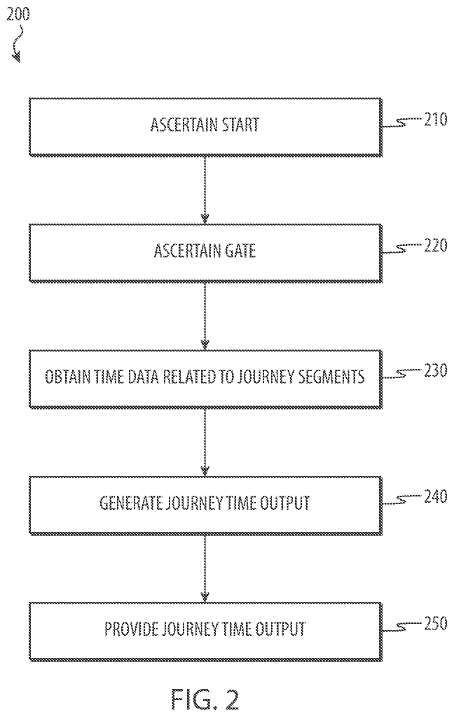

FIG. 2 depicts a flow chart illustrating a first example method 200 for estimating travel time to an airport gate. This method 200 may be performed by the system 100 of FIG. 1.

At operation 210, an electronic device (such as the server computing device 101 of FIG. 1) may ascertain a start for a journey. In some implementations, the electronic device may ascertain the start for the journey based on start data specified in a request, start data retrieved from stored identity information that corresponds to a determined identity of a user (which may be determined using one or more provided digital representations of biometrics, logins, passwords, account identifiers, and so on), start data determined based on a location of a user interaction computing device that submitted the request, and so on.

At operation 220, the electronic device may ascertain a gate for the journey. In some implementations, the electronic device may ascertain the gate for the journey based on airport gate data specified in the request, airport gate data retrieved from stored identity information that corresponds to a determined identity of the user (which may be determined using one or more provided digital representations of biometrics (such as a digital representation of a fingerprint, a voiceprint, a facial image, a retina image, an iris image, a deoxyribonucleic acid sequence, a heart rhythm, a gait, a palm scan, a hand scan, a vein scan, a blood scan, a vein image, and so on obtained via one or more biometric reader devices, such as a fingerprint scanner, a palm scanner, a hand scanner, a vein scanner, a blood scanner, an optical fingerprint scanner, a phosphorescent fingerprint scanner, a camera, an image sensor, a saliva sensor, a deoxyribonucleic acid sensor, a heart rhythm monitor, a microphone, and so on), logins, passwords, account identifiers, and so on), airport gate data determined by accessing a secure flight database or other database using information retrieved from the stored identity information, and so on.

At operation 230, the electronic device may obtain time data related to segments of the journey. In some implementations, the electronic device may obtain driving or other navigation direction time estimates, walk times to gates in airports, current traffic conditions, security processing times at airports, and so on obtained from one or more traffic and/or other data sources via communication with one or more computing devices.

At operation 240, the electronic device may generate the journey time output. The electronic device may generate the journey time output using the start, the gate, the time data, and so on.

At operation 250, the electronic device may provide the journey time output. In some implementations, the electronic device may provide the journey time output by transmitting the journey time output and/or instructions to present such to a user interaction computing device. Various configurations are possible and contemplated without departing from the scope of the present disclosure.

For example, the electronic device may receive a request for a journey time output that specifies the start and the gate. The electronic device may obtain the time data and generate and/or provide the requested journey time output using the specified start and the gate. Various configurations are possible and contemplated without departing from the scope of the present disclosure.

In various examples, this example method 200 may be implemented as a group of interrelated software modules or components that perform various functions discussed herein. These software modules or components may be executed within a cloud network and/or by one or more computing devices, such as the server computing device 101 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as providing the journey time output at operation 250. However, it is understood that this is an example. In some implementations, the journey time output may be generated without providing the journey time output. Various configurations are possible and contemplated without departing from the scope of the present disclosure.

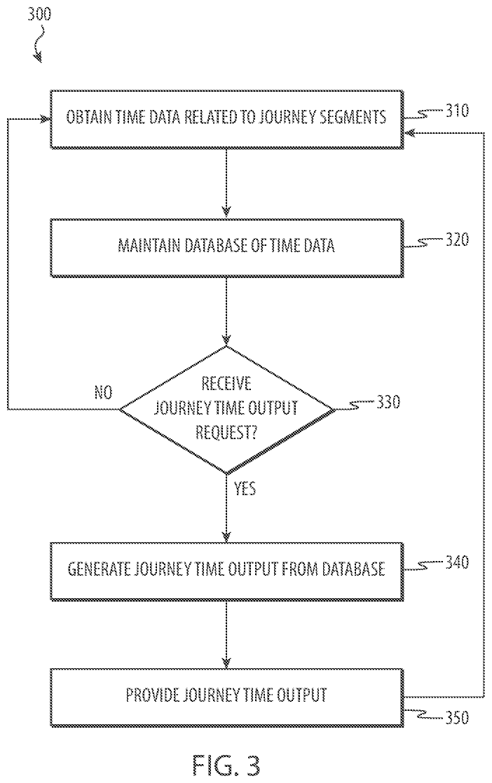

FIG. 3 depicts a flow chart illustrating a second example method 300 for estimating travel time to an airport gate. This method 300 may be performed by the system 100 of FIG. 1.

At operation 310, an electronic device (such as the server computing device 101 of FIG. 1) may obtain time data related to journey segments for journeys between one or more various starts and/or one or more various airport gates. At operation 320, the electronic device may maintain one or more databases of the time data.

At operation 330, the electronic device may determine whether a request for a journey time output is received. If so, the flow may proceed to operation 340. Otherwise, the flow may return to operation 310 where the electronic device may continue to obtain time data.

At operation 340, after the electronic device determines that a request for a journey time output is received, the electronic device may generate the journey time output. The electronic device may generate the journey time output at least using time data from the database. In some implementations, the electronic device may use a combination of time data from the database and currently obtained time data. At operation 350, the electronic device may provide the journey time output.

For example, the electronic device may obtain time data related to various journeys between various start locations and various gates at various airports. The electronic device may maintain a database of this time data in order to be able to generate journey time outputs for a variety of different requests that are received. The electronic device may generate and/or provide such requested journey time outputs upon receipt of such requests. Various configurations are possible and contemplated without departing from the scope of the present disclosure.

In various examples, this example method 300 may be implemented as a group of interrelated software modules or components that perform various functions discussed herein. These software modules or components may be executed within a cloud network and/or by one or more computing devices, such as the server computing device 101 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as obtaining time data prior to receiving a request for a journey time output. However, it is understood that this is an example. In some implementations, the electronic device may obtain the time data before and/or after the request is received. Various configurations are possible and contemplated without departing from the scope of the present disclosure.

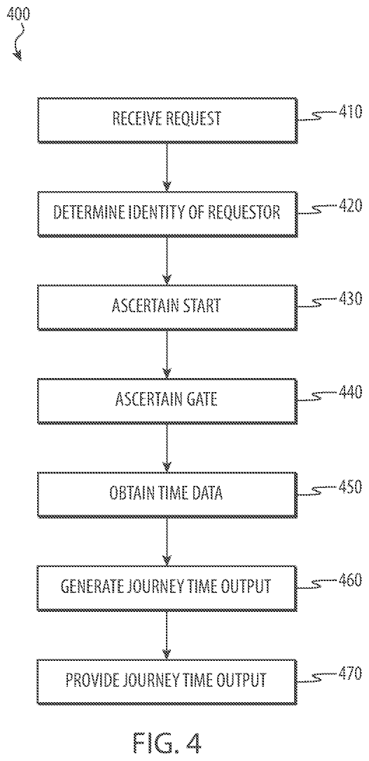

FIG. 4 depicts a flow chart illustrating a third example method 400 for estimating travel time to an airport gate. This method 400 may be performed by the system 100 of FIG. 1.

At operation 410, an electronic device (such as the server computing device 101 of FIG. 1) may receive a request for a journey time estimate associated with a journey. At operation 420, the electronic device may determine an identity of the requestor. In various examples, the identity of the requestor may be determined using identification information, such as one or more provided digital representations of biometrics (such as a digital representation of a fingerprint, a voiceprint, a facial image, a retina image, an iris image, a deoxyribonucleic acid sequence, a heart rhythm, a gait, a palm scan, a hand scan, a vein scan, a blood scan, a vein image, and so on obtained via one or more biometric reader devices, such as a fingerprint scanner, a palm scanner, a hand scanner, a vein scanner, a blood scanner, an optical fingerprint scanner, a phosphorescent fingerprint scanner, a camera, an image sensor, a saliva sensor, a deoxyribonucleic acid sensor, a heart rhythm monitor, a microphone, and so on), logins, passwords, account identifiers, and so on. The electronic device (and/or one or more electronic devices in communication with the electronic device) may store identity information (such as one or more names, addresses, phone numbers, social security numbers, credit card and/or other financial information, payment records, purchase and/or other behavior records, age and/or verified age, driver's license and/or other identification or authorization information, vehicle rental contract information, ticketing information, flight information, frequent flyer information, insurance verification, and so on) associated with the identification information and may determine the identity by comparing the identity information with the stored identity information.

At operation 430, the electronic device may ascertain a start associated with the journey. At operation 440, the electronic device may ascertain a gate associated with the journey. At operation 450, the electronic device may obtain time data related to one or more segments of the journey. At operation 460, the electronic device may generate a journey time output. At operation 470, the electronic device may provide the generated journey time output.

For example, the electronic device may obtain one or more digital representations of a biometric, determine an identity associated with the one or more digital representations of a biometric, ascertain a home address stored in identity information associated with the identity, ascertain an airport gate from flight information associated with the identity information, and then obtain time data and generate and/or present a journey time output using the home address, the airport gate, and/or the time data. Various configurations are possible and contemplated without departing from the scope of the present disclosure.

In various examples, this example method 400 may be implemented as a group of interrelated software modules or components that perform various functions discussed herein. These software modules or components may be executed within a cloud network and/or by one or more computing devices, such as the server computing device 101 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as generating the journey time output. However, it is understood that this is an example. In some implementations, the electronic device may provide the home address, the airport gate, and/or the time data to one or more other electronic devices that may generate the journey time output. Various configurations are possible and contemplated without departing from the scope of the present disclosure.

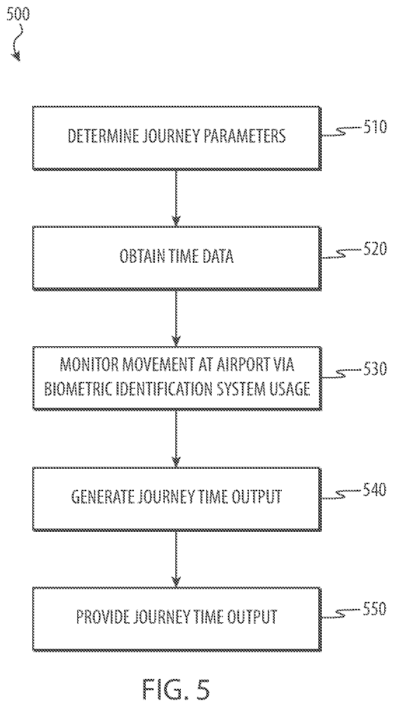

FIG. 5 depicts a flow chart illustrating a fourth example method 500 for estimating travel time to an airport gate. This method 500 may be performed by the system 100 of FIG. 1.

At operation 510, an electronic device (such as the server computing device 101 of FIG. 1) may determine one or more journey parameters. The journey parameters may include a start or origin of the journey, an airport gate at an end of the journey, various constraints for the journey (such as specific routes to use, specific transportation options to use, and so on), and so on. At operation 520, the electronic device may obtain time data related to one or more segments of the journey.

At operation 530, the electronic device may monitor movement at one or more airports via usage of a biometric identification system. For example, data from such a biometric identification system may be used to verify identity for security screening, verify valid identification and/or boarding passes, process payments, and so on. Data from usage of the biometric identification system may be monitored to gather data in order to track and/or estimate movement through various portions of the airports. For example, usage of the biometric identification system may be monitored to gather data in order to track and/or estimate movement time for security processing, movement time for checking baggage, movement time to wait for service at ticket counters, and so on.

At operation 540, the electronic device may generate a journey time output using the journey time parameters, the time data, and/or the movement at the one or more airports. At operation 550, the electronic device may provide the journey time output.

For example, the electronic device may use the data regarding monitored movement at the airport to estimate current security wait times. The electronic device may use this current estimated security wait time as part of generating the journey time output. As such, the journey time output may more accurately reflect the actual time the journey may take as it more accurately reflects the amount of time currently required for passing through security.

In various examples, this example method 500 may be implemented as a group of interrelated software modules or components that perform various functions discussed herein. These software modules or components may be executed within a cloud network and/or by one or more computing devices, such as the server computing device 101 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as monitoring movement at the one or more airports. However, it is understood that this is an example. In some implementations, the electronic device may receive data regarding such movement instead of monitoring such movement itself. Various configurations are possible and contemplated without departing from the scope of the present disclosure.

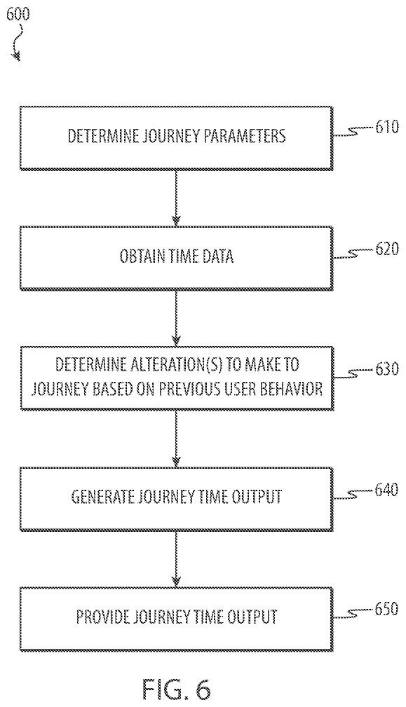

FIG. 6 depicts a flow chart illustrating a fifth example method 600 for estimating travel time to an airport gate. This method 600 may be performed by the system 100 of FIG. 1.

At operation 610, an electronic device (such as the server computing device 101 of FIG. 1) may determine one or more journey parameters for a journey. At operation 620, the electronic device may obtain time data related to one or more segments of the journey.

At operation 630, the electronic device may determine one or more alterations to make to the journey based on previous user behavior. For example, a user may previously have visited a ticket counter before flights even when not checking a bag. This behavior may be monitored and tracked. As such, the electronic device may determine to make an alteration to the journey to include an unnecessary visit to a ticket counter. The electronic device may subsequently provide an indication that the user may save time by skipping the ticket counter (which may be made possible by one or more suggested actions, such as using a biometric identification system for passing through security that does not require the user to obtain a boarding pass). Other alterations may include typical routes taken, typical routes through airports taken, typical visits to airline and/or other lounges while in the airport, and so on. Various configurations are possible and contemplated without departing from the scope of the present disclosure.

At operation 640, the electronic device may generate a journey time output using the journey time parameters, the time data, and/or the alteration(s). The journey time output may include the above mentioned indication, as well as the above mentioned suggested action(s) and/or prompts to re-generate and/or re-present the journey time output based upon the above mentioned suggested action(s). At operation 650, the electronic device may provide the journey time output.

For example, the electronic device may determine that the user is not a member of an expedited security screening service. The electronic device may generate and present the journey time output as well as an indication regarding the expedited security screening service. Upon receipt of a request from the user to become a member of the expedited security screening service, the electronic device may re-generate and re-present the journey time output to account for use of the expedited security screening service. Various configurations are possible and contemplated without departing from the scope of the present disclosure.

In various examples, this example method 600 may be implemented as a group of interrelated software modules or components that perform various functions discussed herein. These software modules or components may be executed within a cloud network and/or by one or more computing devices, such as the server computing device 101 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as determining one or more alterations to make to the journey based on previous user behavior. However, it is understood that this is an example. In some implementations, the electronic device may take the previous user behavior into account when determining the journey parameters. As such, the electronic device may then omit determining any alterations to make to the journey based on the previous user behavior. Various configurations are possible and contemplated without departing from the scope of the present disclosure.

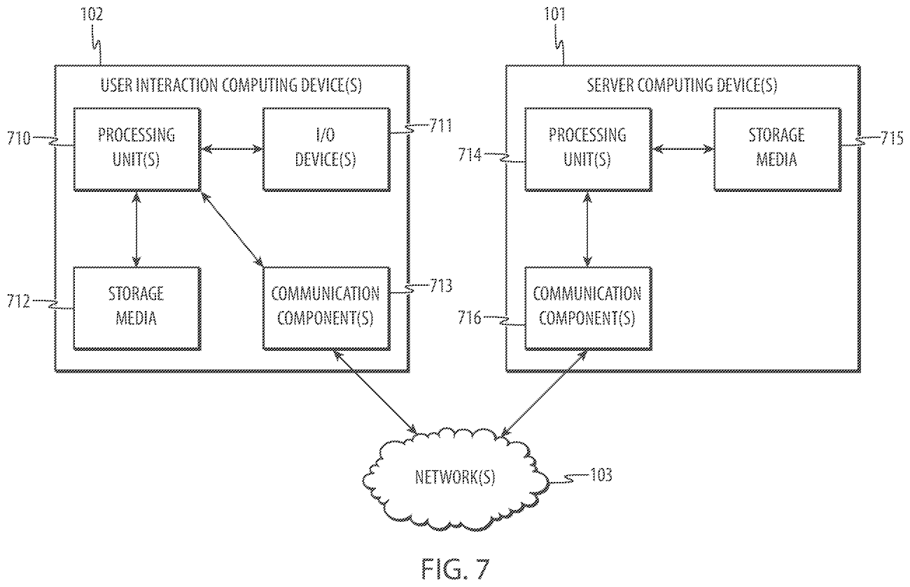

FIG. 7 depicts a block diagram illustrating example relationships between example components that may be used to implement the user interaction computing device 102 and the server computing device 101 of the system 100 of FIG. 1.

The user interaction computing device 102 may be any kind of device. Examples of such devices include, but are not limited to, one or more desktop computing devices, laptop computing devices, mobile computing devices, wearable devices, tablet computing devices, mobile telephones, smart phones, printers, displays, vehicles, kitchen appliances, vaporizers, entertainment system devices, digital media players, smart houses or other smart buildings, and so on. The user interaction computing device 102 may include one or more processors 710 and/or other controllers and/or processing units, one or more non-transitory storage media 712 (which may take the form of, but is not limited to, a magnetic storage medium; optical storage medium; magneto-optical storage medium; read only memory; random access memory; erasable programmable memory; flash memory; and so on), one or more communication units 713, one or more input and/or output devices 711 (such as one or more biometric reader devices, buttons, microphones, displays, touch screens, touch panels, computer mice, track pads, sensors, and so on). The processor may execute one or more sets of instructions stored in the non-transitory storage media to perform various functions, such as to receive user input and/or provide user output via the input and/or output device 711, communicate with the server computing device 101 via the communication unit 713 and the network 103, and so on.

Similarly, the server computing device 101 may include one more processors 714 and/or other controllers and/or processing units, non-transitory storage media 715, communication units 716, and/or other components (such as one or more biometric reader devices, buttons, microphones, displays, touch screens, touch panels, computer mice, track pads, sensors, and so on). The processor may execute one or more sets of instructions stored in the non-transitory storage media to perform various functions, such as to perform one or more of the methods 200-600 of FIGS. 2-6, communicate with the user interaction computing device 102 via the communication unit 716 and the network 103, and so on.

In some implementations, the user interaction computing device 102 may be operable to receive identification information, such as one or more hashes and/or other digital representations of one or more biometrics, one or more account logins, one or more passwords, and so on. The user interaction computing device 102 may transmit the identification information directly and/or indirectly to the server computing device 101. The server computing device 101 may determine whether the identification information is associated with stored identity information (such as one or more names, addresses, phone numbers, social security numbers, credit card and/or other financial information, payment records, purchase and/or other behavior records, age and/or verified age, driver's license and/or other identification or authorization information, vehicle rental contract information, insurance verification, and so on). If so, the server computing device 101 may return and/or otherwise allow access to associated identity information and/or one or more attestations regarding such directly and/or indirectly to the user interaction computing device 102 (such as whether a person is of at least a certain age, whether or not a person is authorized to operate a vehicle, and so on). The user interaction computing device 102 may use the identity information and/or attestation regarding such to perform various functions related to various operations discussed herein.

In various implementations, a system for estimating travel time to an airport gate may include a non-transitory storage medium that stores instructions and a processor. The processor may execute the instructions to ascertain a start and the airport gate for a journey, obtain time data related to segments of the journey, generate a journey time output, and provide the journey time output.

In some examples, the journey time output may include at least a first estimated time to travel from the start to an airport associated with the airport gate, a second estimated time to pass through security screening, and a third estimated time to travel from the security screening to the airport gate. In a number of such examples, the journey time output may further include a total estimated time generated at least by adding the first estimated time, the second estimated time, and the third estimated time. In some such examples, the journey time output may further include a fourth estimated time to check baggage. In various such examples, the journey time output may further include a fourth estimated time for service at a ticket counter.

In a number of examples, obtaining the time data may include obtaining traffic data from a traffic data source, the traffic data related to one of the segments of the journey from the start to an airport associated with the airport gate. In various examples, obtaining the time data may include obtaining a walk time from a database of airport walk times to gates.

In some embodiments, a system for estimating travel time to an airport gate may include a non-transitory storage medium that stores instructions and a processor. The processor may execute the instructions to obtain time data related to segments of journeys to airport gates, maintain a database of the time data, receive a request for a journey time output associated with a journey, generate the journey time output using at least the database, and provide the journey time output.

In various examples, the request may specify the airport gate for the journey. In a number of examples, the request may specify a start for the journey.

In some examples, the processor may modify the journey time output in response to a change request. In various such examples, the change request may change a route to an airport associated with the journey. In some such examples, the change request may change a method of travel to an airport associated with the journey.

In a number of embodiments, a system for estimating travel time to an airport gate may include a non-transitory storage medium that stores instructions and a processor. The processor may execute the instructions to receive a request for a journey time output from a requestor, determine an identity of the requestor, ascertain a start and the airport gate for a journey, obtain time data related to the journey, determine at least one alteration to make to the journey based on previous behavior associated with the identity, and generate the journey time output.

In various examples, the processor may determine the airport gate based at least on ticket data associated with the identity. In some examples, the processor may determine the start based at least on address information associated with the identity. In a number of examples, the processor may determine the start based at least on a current location of an electronic device associated with the identity. In some examples, the processor may determine the start based at least on a current location of an electronic device used to submit the request. In various examples, the processor may transmit the journey time output to an electronic device used to submit the request. In a number of examples, the processor may provide a suggestion regarding an alternative behavior resulting in a shorter estimated journey time.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to estimation and presentation of total journey time from origin to gate. A start and an airport gate for a journey may be ascertained. Time data related to segments of the journey may be obtained. For example, driving or other navigation direction time estimates may be obtained, walk times to gates in airports may be obtained, current traffic conditions may be obtained, security processing times at airports may be obtained, and so on. A journey time output may be generated using the time data. The journey time output may be provided, such as in the form of a unified timeline from a person's home or other start or origin to the airport gate.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for estimating travel time to an airport gate, comprising:
a non-transitory storage medium that stores instructions; and
a processor that executes the instructions to:
ascertain a start and the airport gate for a journey;
obtain time data related to segments of the journey;
generate a journey time output; and
provide the journey time output.

2. The system of claim 1, wherein the journey time output includes at least:
a first estimated time to travel from the start to an airport associated with the airport gate;
a second estimated time to pass through security screening; and
a third estimated time to travel from the security screening to the airport gate.

3. The system of claim 2, wherein the journey time output further includes a total estimated time generated at least by adding the first estimated time, the second estimated time, and the third estimated time.

4. The system of claim 2, wherein the journey time output further includes a fourth estimated time to check baggage.

5. The system of claim 2, wherein the journey time output further includes a fourth estimated time for service at a ticket counter.

6. The system of claim 1, wherein obtaining the time data includes obtaining traffic data from a traffic data source, the traffic data related to one of the segments of the journey from the start to an airport associated with the airport gate.

7. The system of claim 1, wherein obtaining the time data includes obtaining a walk time from a database of airport walk times to gates.

8. A system for estimating travel time to an airport gate, comprising:
a non-transitory storage medium that stores instructions; and
a processor that executes the instructions to:
obtain time data related to segments of journeys to airport gates;
maintain a database of the time data;
receive a request for a journey time output associated with a journey;
generate the journey time output using at least the database; and
provide the journey time output.

9. The system of claim 8, wherein the request specifies the airport gate for the journey.

10. The system of claim 8, wherein the request specifies a start for the journey.

11. The system of claim 8, wherein the processor modifies the journey time output in response to a change request.

12. The system of claim 11, wherein the change request changes a route to an airport associated with the journey.

13. The system of claim 11, wherein the change request changes a method of travel to an airport associated with the journey.

14. A system for estimating travel time to an airport gate, comprising:
a non-transitory storage medium that stores instructions; and
a processor that executes the instructions to:
receive a request for a journey time output from a requestor;
determine an identity of the requestor;
ascertain a start and the airport gate for a journey;
obtain time data related to the journey;
determine at least one alteration to make to the journey based on previous behavior associated with the identity; and
generate the journey time output.

15. The system of claim 14, wherein the processor determines the airport gate based at least on ticket data associated with the identity.

16. The system of claim 14, wherein the processor determines the start based at least on address information associated with the identity.

17. The system of claim 14, wherein the processor determines the start based at least on a current location of an electronic device associated with the identity.

18. The system of claim 14, wherein the processor determines the start based at least on a current location of an electronic device used to submit the request.

19. The system of claim 14, wherein the processor transmits the journey time output to an electronic device used to submit the request.

20. The system of claim 14, wherein the processor provides a suggestion regarding an alternative behavior resulting in a shorter estimated journey time.
